(19) United States
(12) Patent Application Publication
(10) Pub. No.: US 2009/0290386 A1
(43) Pub. Date: Nov. 26, 2009

(54) Photocoupler and switching power supply circuit

(75) Inventors: Masakazu Ikeda, Osaka-Shi (JP); Masaru Kubo, Osaka-Shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/454,747

(22) Filed: May 21, 2009

(30) Foreign Application Priority Data
May 21, 2008 (JP) 2008-132646

(51) Int. Cl. H02M 3/335

(52) U.S. Cl. 363/19

(57) ABSTRACT

A photocoupler for feeding back output voltage information on a secondary side of a switching power supply circuit through a light signal to control a switching operation on a primary side comprises: a light-emitting element for emitting a light signal flashing based on the output voltage information of the switching power supply circuit; a light-receiving control integrated circuit composed by integrating a light-receiving element composed of a photodiode for receiving the light signal, an amplifier circuit for amplifying an output signal of the light-receiving element, and a switching control circuit for controlling the switching operation of the switching power supply circuit, in one chip, wherein the light-emitting element and the light-receiving control integrated circuit are sealed in one package so that the light signal can be transmitted from the light-emitting element to the light-receiving element.

### CROSS REFERENCE TO RELATED APPLICATION

This Nonprovisional application claims priority under 35 U.S.C. §119(a) on Patent Application No. 2008-132646 filed in Japan on May 21, 2008, the entire contents of which are hereby incorporated by reference.

### BACKGROUND OF THE INVENTION

1. Field of the Invention

The present invention relates to a photocoupler used in a switching power supply circuit and the switching power supply circuit having the photocoupler and more particularly, to a switching power supply circuit used in an AC adaptor and an LED to generate a DC voltage from a commercial AC power supply.

2. Description of the Related Art

As one example of a conventional switching power supply circuit, switching power supplies are disclosed in the following documents 1 to 3. FIGS. 15 to 17 show circuit diagrams of the switching power supply disclosed in the documents 1 to 3, respectively.

Document 1: “TNY274-280, TinySwitch-III Family, Energy Efficient, Offline Switcher with Enhanced Flexibility and Extended Power Range”, FIG. 1, [online], [searched on May 8, 2008], Internet <URL: http://www.powerint.com/PDFFiles/tny274-280.pdf>

Document 2: “Product Specification, Highly Integrated Green-Mode PWM Controller SG5841/J”, Drawing on the first page, [online], [searched on May 8, 2008], Internet <URL: http://pdf1.alldatasheet.com/datasheet-pdf/view/202762/FAIRCHILD/SG5841. html>

Document 3: “Transistor Technology”, CQ Publishing, issued in March 1997, p. 275, FIG. 9

A switching power supply circuit (conventional example 1) shown in FIG. 15 is configured such that a switching operation controlling IC produced through a high voltage process, and a photocoupler using a phototransistor as a light receiving element are combined. An operation of the conventional example 1 will be briefly described hereinafter.

A DC voltage provided by rectifying and smoothing an AC voltage is applied between a pair of DC supply terminals HV+ and HV− (rectifying and smoothing circuits of the AC voltage are not shown). An IC 101 serving as a switching power supplying IC produced through the high voltage process starts on/off operations (switching operation) between a D terminal and an S terminal, and a sawtooth current flows in a primary side (primary winding L101) of a transformer T101. Thus, an AC voltage is generated on a secondary side (secondary winding L201) of the transformer T101 and rectified by a diode D102 to be a pulsating voltage and smoothed by a capacitor C103 to be a DC voltage, so that the DC output voltage is generated between DC output terminals DC+ and DC−.

When the output voltage exceeds the zener voltage of a diode D103, a light-emitting diode D104 of a photocoupler is turned on, and light-emitting information of the light-emitting diode D104 is received by a phototransistor Q101 of a photocoupler PC101, so that the fact that the output voltage exceeded the zener voltage is transmitted to the controlling IC 101. When the controlling IC 101 receives the information that the output voltage exceeded the zener voltage, it stops the switching operation. As a result, since the power transfer from the primary side to the secondary side of the transformer T101 is stopped, the output voltage between the DC output terminals DC+ and DC− is lowered. When the output voltage falls below the zener voltage, the light-emitting diode D104 is turned off and the switching operation of the controlling IC 101 is started again. Thus, the output voltage between the DC output terminals DC+ and DC− is kept constant by repeating the above operations.

In addition, a diode D101, a resistor R101, and a capacitor C101 configure a snubber circuit to clip a high voltage generated when the controlling IC 101 is turned off between the D terminal and the S terminal.

A switching power supply circuit (conventional example 2) shown in FIG. 16 is configured such that a switching operation controlling IC produced through a middle and low voltage process and a photocoupler having a phototransistor as a light receiving element and an auxiliary winding (tertiary winding) are combined. An operation of the conventional example 2 will be briefly described.

When an AC voltage is applied between a pair of AC supply terminals L and N, it is rectified by a diode D201 and smoothed by a capacitor C201, so that a DC voltage is generated between both terminals of the capacitor C201. The DC voltage is applied to a starting input terminal VIN of a controlling IC 201 through a resistor R201, and the controlling IC 201 is started and a rectangular wave is generated in a terminal GATE. A transistor Q201 is turned on/off (switching operation) between the drain and the source in synchronization with the rectangular wave, and a sawtooth current flows in a primary side (primary winding L201) of a transformer T201 connected to the transistor Q201. Meanwhile, an AD voltage is generated in a secondary side (secondary winding L202) of the transformer T201 and rectified by a diode D204 to be a pulsating voltage and smoothed by capacitors C206 and C207 to be a DC voltage, so that DC output voltage is generated between DC output terminals VO+ and VO−.

According to the conventional example 2, the transformer T201 has a tertiary winding L203 in addition to the primary winding L201 and the secondary winding L202, and an AC voltage generated in the tertiary winding L203 is rectified by a diode D203 and smoothed by a capacitor C203 and applied to a power supply terminal VDD of the controlling IC 201, so that the power is supplied to the controlling IC 201.

The output voltage is divided by a resistor R210 and a resistor R211 and when its divided value (middle voltage of the resistor R210 and the resistor R211) exceeds a reference voltage of a voltage detecting IC 202, a light-emitting diode D206 of the photocoupler is turned on, and the light-emitting information of the light-emitting diode D206 is received by a phototransistor Q202 of a photocoupler PC201, so that the fact that the divided voltage value exceeded the reference voltage of the voltage detecting IC 202 is transmitted to the controlling IC 201. When the controlling IC 201 receives the information that the divided voltage value exceeded the reference voltage, it stops the switching operation. As a result, since the power transfer from the primary side to the secondary side of the transformer T201 is stopped, the output voltage between the DC output terminals VO+ and VO− is lowered. When the divided voltage value falls below the reference voltage, the light-emitting diode D206 is turned off and the switching operation of the controlling IC 201 is started again. Thus, the divided voltage value is kept constant by repeating the above operations, and the output voltage between the DC output terminals VO+ and VO− is kept constant.

In addition, a diode D202, a resistor R202, and a capacitor C202 configure a snubber circuit to clip a high voltage generated when the transistor Q201 is turned off between the drain and the source.

A switching power supply circuit (conventional example 3) shown in FIG. 17 is configured such that a discrete component, a photocoupler using a phototransistor as a light receiving element, and an auxiliary winding (tertiary winding) are combined. An operation of the conventional example 3 will be briefly described hereinafter. In addition, the conventional example 3 is generally known as a RCC (Ringing Choke Converter) system, and it is the switching power supply circuit widely used in a battery charger of a mobile phone and the like.

A DC voltage provided by rectifying and smoothing an AC voltage (rectifying and smoothing circuits of the AC voltage are not shown) is applied between a DC supply terminal +Vin and a ground terminal V0. This state is an initial state. A current flows to the base of a transistor Q301 through a resistor Rg, the current flows between the collector and emitter of the transistor Q301, and the current flows in a primary side (primary winding L301) of a transformer T301, so that a voltage is generated in a tertiary winding L303 of the transformer T301. The voltage generated in the tertiary winding L303 allows a current to flow to the base of the transistor Q301 through a diode D301 and a resistor R301.

The current flowing in a primary winding L301 is linearly increased with time due to an inductance component of the primary winding L301, and a magnetic flux in the transformer T301 is also linearly increased with time. Since the voltage (electromotive force) generated in the tertiary winding L303 is proportional to the temporal change of the magnetic flux, a constant voltage is generated temporally. Therefore, the base current of the transistor Q301 is a current which flows from the tertiary winding L303 to which a temporally constant voltage is applied and from the resistor Rg, so that it is temporally constant. Therefore, the collector current of the transistor Q301 is less than hfe times as large as the constant base current. When the collector current reaches the current upper limit value, since there is no temporally change in current due to the primary winding L301, there is no temporally change in the magnetic flux in the transformer T301 and there is also no electromotive power of the tertiary winding L303, so that the base current of the transistor Q301 begins to be decreased and the current of the primary winding L301 begins to be decreased. As a result, since the temporally change in the magnetic flux in the transformer T301 begins to be decreased contrary to the above, the electromotive force of the tertiary winding L303 becomes an opposite polarity to the above, the base current of the transistor Q301 is decreased, and the collector current of the transistor Q301 becomes zero eventually. As a result, the current of the primary winding L301 becomes zero and the electromotive force of the tertiary winding L303 becomes zero, so that the state returns to the initial state.

By repeating the above operations, the transistor Q301 oscillates, the collector current, that is, the current in the primary side of the transformer T301 is increased and decreased repetitively, and an AC voltage is generated in a secondary winding L302 on the secondary side of the transformer T301. The AC voltage generated in a secondary winding L302 is rectified by a diode D303 and smoothed by a capacitor C303, so that a DC output voltage is generated between a DC output terminal Vout and the ground terminal V0.

The output voltage is divided by a resistor Ra and a resistor Rb and when its divided value (middle voltage of the resistor Ra and the resistor Rb) exceeds a reference voltage of a voltage detecting IC 301, a current flows in a light-emitting diode D304 of the photocoupler to be turned on. Then, when a phototransistor Q303 of the photocoupler receives the light emission of the light-emitting diode D304, the base current flows in a transistor Q302 from the tertiary winding L303 through a diode D302 and a resistor R302. As a result, since the current flows from the collector to the emitter of the transistor Q302, the base current flowing in the transistor Q301 is decreased, the collector current of the transistor Q301 is decreased, the current on the primary side of the transformer T301 is decreased, and power transfer of the transformer T301 to the secondary side is decreased, so that the output voltage between the DC output terminal Vout and the ground terminal V0 is lowered. When the divided voltage value falls below the reference voltage of the voltage detecting IC 301, since the light-emitting diode D304 is turned off and the transistor Q301 begins to oscillate, the output voltage between the DC output terminal Vout and the ground terminal V0 is raised. By repeating the above operations, the divided voltage value is kept constant and the output voltage between the DC output terminal Vout and the ground terminal V0 is kept constant.

According to the conventional switching power supply circuit, since the photocoupler of the phototransistor is used as the light-receiving element, there are following five problems, such as 1) a component mounting area is large, 2) peripheral components (transformer, diode, capacitor) are large, 3) output error (ripple) is large, 4) the signal current of the phototransistor is large and its current consumption is large, and 5) the drive current of the light-emitting diode is large and its current consumption is large.

As for the first problem (the component mounting area is large), in any one of the above three conventional examples (conventional examples 1 to 3), since the photocoupler is used to feed back the output voltage information on the secondary side of the transformer to the oscillation circuit or the switching operation controlling IC on the primary side, and the switching operation controlling IC or the switching operation controlling discrete component is mounted on the primary side, the component mounting area is large.

As for the second problem (peripheral components (transformer, diode, capacitor) are large), since the phototransistor is used as the light-receiving element, and the general light-emitting diode formed of GaAs is used as the light-emitting element in the photocoupler of the conventional switching power supply circuit, each of the rising time and falling time of the signal is about 5 μs, and the practical frequency is 100 kHz. These rising time and falling time are determined based on the fact that the high-frequency component of the signal waveform cannot be transmitted due to a mirror effect of the capacity viewed from the input side of the phototransistor. Especially, although the gain of the phototransistor is increased to increase the light-receiving sensitivity, the mirror effect becomes evident as the gain is increased, so that it is difficult to transmit the high-frequency signal. Due to this problem in the signal voltage speed, the switching speed is about 100 kHz, and the peripheral components (transformer, diode, capacitor) are large.

As for the third problem (output error (ripple) is large), as described in the second problem, since the switching speed of the conventional switching power supply circuit is up to about 100 kHz, the ripple is large. When the smoothing capacitor, for example is increased in size to reduce the ripple, the problem is that the following speed of the power supply with respect to the fluctuation of the output is reduced.

As for the fourth problem (the signal current of the phototransistor is large and its current consumption is large), since the phototransistor is used as the light-receiving element of the photocoupler in the conventional switching power supply circuit, a signal current needs to be 1 mA in order to ensure sufficient light-receiving sensitivity and prevent the effect of the noise. More specifically, when it is assumed that the drive voltage of the controlling IC is 10V, the output is no load, and the light-emitting diode is turned on at a duty ratio of 80%, an average current of 0.8 mA flows in the collector of the phototransistor, and 8 mW is lost in the light-receiving element.

As for the fifth problem (the drive current of the light-emitting diode is large and its current consumption is large), since the phototransistor is used as the light-receiving element of the photocoupler in the conventional switching power supply circuit, the drive current of the light-emitting diode needs to be about 10 mA. More specifically, when it is assumed that the output voltage of the switching power supply circuit is 5V, the output is no load, and the light-emitting diode is turned on at a duty ratio of 80%, an average current of 8 mA flows in the light-emitting diode, and 40 mW is lost in the light-emitting diode. According to the product plugged in all the time, such as the battery charger of the mobile phone, the power consumption at the time of no load is required to be 50 to 100 mW in the market, so that it is difficult to satisfy the requirement in the market by the conventional switching power supply circuit in which 40 mW is lost in the light-emitting diode only.

Furthermore, in addition to the above five problems, as a sixth problem, since the switching operation controlling IC produced through the high voltage process is used in the switching power supply circuit in the conventional example 1, the production cost of the controlling IC is high, which causes the cost of the switching power supply circuit to soar as a whole.

### SUMMARY OF THE INVENTION

The present invention was made in view of the above problems of the conventional switching power supply circuit, and it is an object to provide a photocoupler and a switching power supply circuit in which a component mounting area and a peripheral component can be miniaturized and an error of an output voltage and power consumption can be suppressed.

A photocoupler according to the present invention in order to achieve the above object is provided to feed back output voltage information on the secondary side of a switching power supply circuit through a light signal to control a switching operation on the primary side, and characterized as a first characteristic by comprising a light-emitting element for emitting a light signal flashing based on the output voltage information of the switching power supply circuit, and a light-receiving control integrated circuit composed by integrating a light-receiving element composed of a photodiode for receiving the light signal emitted from the light-emitting element, an amplifier circuit for amplifying an output signal of the light-receiving element, and a switching control circuit for controlling the switching operation of the switching power supply circuit, in one chip, in which the light-receiving control integrated circuit comprises a pair of power supply terminals supplied with a DC power supply voltage, and an output terminal for outputting a switching control signal to control the switching operation, and the light-emitting element and the light-receiving control integrated circuit are sealed in one package so that the light signal can be transmitted from the light-emitting element to the light-receiving element.

According to the photocoupler having the first characteristic, since a photocoupler unit composed of the light-emitting element and the light-receiving element, the amplifier circuit for amplifying the output signal of the light-receiving element, and the switching control circuit for controlling the switching operation of the switching power supply circuit are sealed and integrated in one package, the number of components configuring the switching power supply circuit is reduced, a component mounting area is miniaturized, so that the first problem of the conventional switching power supply circuit can be solved. Here, since the light-receiving element and the amplifier circuit and the switching control circuit are provided in one chip, the size of the package is miniaturized and the above elements and circuits can be sealed in one package. In addition, as for the miniaturization, as compared with the package of the controlling IC used in the conventional examples 1 and 2, about 55 to 65 mm² can be reduced, and as compared with the conventional example 3, about 100 to 150 mm² can be reduced due to reduction in discrete component number.

Furthermore, when a photodiode is used as the light-receiving element, since the rising and falling times of the signal on the light-receiving element side can be shortened and the switching operation can be increased in speed as compared with the conventional case where the phototransistor is used as the light-receiving element, the peripheral components such as the transformer, diode and capacitor of the switching power supply circuit can be miniaturized. For example, since the rising and falling times of the signal on the light-receiving element can be as short as 3 ns, and the time can be shortened to about 0.7 μs in the photocoupler part combined with the light-emitting element, while the practical frequency is 100 kHz in the conventional case where the phototransistor is used as the light-receiving element, it can be 700 kHz that is seven times as fast as the conventional case, so that the peripheral components such as the transformer, the diode and the capacitor can be miniaturized to be one seventh. Furthermore, when the peripheral components such as the transformer, diode and the capacitor are miniaturized, the following speed of the peripheral components with respect to the voltage fluctuation of the output on the secondary side of the switching power supply circuit can be increased, so that the voltage fluctuation can be effectively prevented. Thus, the second and third problems of the conventional switching power supply circuit can be solved. Especially, when the switching power supply circuit is used in a communication device and an acoustic device, since it is important to reduce the ripple of the power supply voltage and prevent the a noise from being mixed in a signal to prevent the error operation and the noise generation, the above effect of preventing voltage fluctuation can be more preferable in the above devices.

In addition, when the photodiode is used as the light-receiving element, since the drive current can be low, and the power loss in the light-receiving element can be considerably suppressed as compared with the conventional case where the phototransistor is used as the light-receiving element, so that the power consumption can be reduced. Furthermore, since the photodiode is used as the light-receiving element, and the amplifier circuit for amplifying the output signal of the light-receiving element is provided at a subsequent stage, and they are made into one chip, the light-receiving sensitivity of the light-receiving element can be considerably improved as compared with the conventional phototransistor, so that the drive current on the light-emitting element side can be reduced and the power consumption can be lowered. When it is assumed that the voltage gain is about 10000 times in the amplifier circuit provided in the subsequent stage of the light-receiving element, since the current flowing in the light-receiving element is about 10 μA, the current consumption combined with the amplifier circuit can be reduced to 0.1 mA, so that the power consumption around the light-receiving element at the time of no load can be suppressed to 0.5 mW, which satisfies the market requirement such as 50 to 100 mW. As described above, the above fourth and fifth problems of the conventional switching power supply circuit can be solved.

The photocoupler having the first characteristic according to the present invention is characterized as a second characteristic in that the light-receiving control integrated circuit comprises a current control transistor and a current control circuit in the one chip, the current control transistor is provided between the pair of power supply terminals of the light-receiving control integrated circuit and controls a power supply current flowing between the pair of power supply terminals, and the current control circuit controls a current flowing in the current control transistor so that the voltage between the pair of power supply terminals falls within a predetermined voltage range.

According to the photocoupler having the second characteristic, even when the fluctuation of the current consumption except for the current control transistor and the current control circuit of the light-receiving control integrated circuit is large, and the high DC voltage inputted to the primary side of the switching power supply circuit is stepped down by a high resistance element and the like to be supplied as the power supply voltage of the light-receiving control integrated circuit, since the fluctuation of the voltage stepped down by the high resistance element is prevented and accordingly the fluctuation of the power supply voltage of the light-receiving control integrated circuit is prevented, the one-chip light-receiving control integrated circuit can be produced through a low and middle voltage process, so that the production cost can be lowered. Therefore, the sixth problem of the conventional switching power supply circuit can be solved.

Furthermore, according to the photocoupler having the second characteristic, since the one-chip light-receiving control integrated circuit can be produced through the low and middle voltage process, and the high DC voltage inputted to the primary side of the switching power supply circuit is stepped down by the high resistance element to be supplied as the power supply voltage of the light-receiving control integrated circuit, the power supply by use of the tertiary winding of the transformer in the conventional examples 2 and 3 is not needed, and the tertiary winding and its peripheral components such as a capacitor and a diode for rectifying and smoothing are not needed.

In addition, according to the second characteristic, the higher the DC voltage inputted to the primary side of the switching power supply circuit with respect to the withstand voltage of the light-receiving control integrated circuit is, or the larger the fluctuation of the current consumption of the light-receiving control integrated circuit is, the more its effect can be achieved.

The photocoupler having the first or second characteristic according to the present invention is characterized as a third characteristic in that the light-receiving control integrated circuit comprises an output drive circuit part for outputting the switching control signal of the switching control circuit and a light-receiving circuit part composed of the light-receiving element and the amplifier circuit, wherein the output drive circuit part and the light-receiving circuit part are arranged at two opposed sides so as to be apart from each other in the one chip, and the circuits other than the above two circuit parts are arranged between the two circuit parts.

According to the photocoupler having the third characteristic, since the photodiode is used as the light-receiving element, a bias current is small as compared with the conventional case where the phototransistor is used, so that it is likely to receive the effect of the noise. However, since the output drive circuit part in which intense noise is likely to be generated and the light-receiving circuit part in which the circuits are susceptible to the effect of the noise are arranged so as to be apart from each other, the light-receiving circuit part is not likely to be affected by the noise, so that the control of the switching operation can be stabilized.

The photocoupler having any one of the above characteristics according to the present invention is characterized as a fourth characteristic in that the light-receiving element comprises a first light-receiving element for receiving the light signal, and a second light-receiving element having a shielded light-receiving part so as not to receive the light signal and having the same dark current characteristic as that of the first light-receiving element, and the amplifier circuit comprises a first amplifier circuit for amplifying an output signal of the first light-receiving element, a second amplifier circuit for amplifying an output signal of the second light-receiving element, the second amplifier circuit having the same circuit configuration as the first amplifier circuit, and a differential amplifier circuit for amplifying the difference between an output of the first amplifier circuit and an output of the second amplifier circuit.

According to the photocoupler having the fourth characteristic, even in the case where the dark current when the first light-receiving element does not receive the light signal is large, since the light signal is detected by the difference from the dark current of the first light-receiving element, the light-receiving sensitivity is improved, so that the drive current of the light-emitting element can be reduced and the current consumption can be small. In addition, since the differential amplifier circuit is used, even when the common mode noise is superimposed onto the two combinations such as the first light-receiving element and the first amplifier circuit, and the second light-receiving element and the second amplifier circuit, the common noises are canceled by the differential amplifier circuit, so that the noise resistance of the light-receiving element and the amplifier circuit can be improved. As a result, since the photodiode is used as the light-receiving element, although it is likely to be affected by the noise as compared with the conventional case where the phototransistor is used, the resistance to the noise generated in the light-receiving control integrated circuit and the resistance to the noise entering the light-receiving control integrated circuit can be improved.

The photocoupler having any one of the above characteristics according to the present invention is characterized as a fifth characteristic in that the light-receiving control integrated circuit comprises a metal shield film covering a chip surface, and a part of the metal shield film is open so that the light signal can be inputted to the light-receiving element.

According to the photocoupler having the fifth characteristic, since the photodiode is used as the light-receiving element, although the resistance to the charging on the chip surface of the light-receiving control integrated circuit is low and the polarity could be reversed due to the charging and an erroneous operation could be generated in the light-receiving element as compared with the conventional example in which the phototransistor is used, since the chip surface is covered with the metal shield film except for the light receiving part receiving the light signal, the effect due to the charging can be considerably reduced and the erroneous operation of the light-receiving element is prevented. Therefore, in the case where the photocoupler is used in circumstances in which a voltage higher than usual could be applied between the primary side circuit and the secondary side circuit of the switching power supply circuit, and the insulation between the primary and secondary circuits is required to be reinforced, even when the high voltage is applied to the primary and secondary circuits due to lightning stroke while the circuit is connected to the commercial AC power supply, for example, the light-receiving element of the light-receiving control integrated circuit is prevented from erroneously operating and inappropriate switching operation control can be avoided.

The photocoupler having the any one of the above characteristics is characterized as a sixth characteristic in that a first lead frame mounted with the light-receiving element and having a lead terminal electrically connected to an input terminal of the light-receiving element by wire bonding, and a second lead frame mounted with the light-receiving control integrated circuit and having a lead terminal electrically connected to the pair of power supply terminals and the output terminal of the light-receiving control integrated circuit by wire bonding are arranged such that their chip mounted surfaces are apart from each other in a thickness direction in the one package.

According to the photocoupler having the sixth characteristic, since the light-emitting element and the light-receiving control integrated circuit are sealed in one package such that the light-emitting part of the light-emitting element for emitting the light signal and the light-receiving part of the light-receiving element for receiving the light signal are opposed to each other, and the light-emitting element and the light-receiving control integrated circuit are housed so as to be aligned in the thickness direction of the package, the package can be miniaturized.

The photocoupler having the sixth characteristic is characterized as a seventh characteristic in that the first lead frame, the second lead frame, the light-emitting element and the light-receiving control integrated circuit are arranged in the one package such that the wire bonding on the first lead frame is not opposed to the light-receiving element of the light-receiving control integrated circuit on the second lead frame in the thickness direction.

According to the photocoupler having the seventh characteristic, even when a voltage higher than usual is applied between the primary side circuit and the secondary side circuit of the switching power supply circuit, since the wire bonding of the light-emitting element existing in the secondary side circuit and the light-receiving element existing in the primary side circuit are prevented from being brought close to each other, the light-receiving element is not directly affected by an intense electric field due to the high voltage application.

The photocoupler having the sixth characteristic according to the present invention is characterized as an eighth characteristic in that the first lead frame, the second lead frame, the light-emitting element and the light-receiving control integrated circuit are arranged in the one package such that the wire bonding on the first lead frame is not opposed to the light-receiving control integrated circuit on the second lead frame in the thickness direction, and the wire bonding on the second lead frame is not opposed to the light-emitting element on the first lead frame in the thickness direction.

The photocoupler having the sixth characteristic according to the present invention is characterized as an ninth characteristic in that the first lead frame, the second lead frame, the light-emitting element and the light-receiving control integrated circuit are arranged in the one package such that the wire bonding on the first lead frame is not opposed to the second lead frame in the thickness direction, and the wire bonding on the second lead frame is not opposed to the first lead frame in the thickness direction.

According to the photocoupler having the eighth or ninth characteristic, similar to the photocoupler having the seventh characteristic, even when a voltage higher than usual is applied between the primary side circuit and the secondary side circuit of the switching power supply circuit, the light-receiving element can be prevented from being directly affected by the intense electric field due to the high voltage application.

The photocoupler having any one of the first to ninth characteristics is characterized as a tenth characteristic in that the light-emitting element is formed of a light-emitting diode composed of a GaAlAs compound semiconductor.

According to the photocoupler having the tenth characteristic, since the rising and falling times of the signal on the side of the light-emitting element can be shortened and the speed of the switching operation can be increased, the peripheral components such as the transformer, diode, capacitor of the switching power supply circuit can be further miniaturized. For example, since both rising and falling times of the signal in the photocoupler part composed of the light-emitting element and the light-receiving element can be reduced to 0.1 μs, the practical frequency can be as fast as 5 MHz. Thus, since the transformer that has hindered the switching power supply circuit from being miniaturized can be further miniaturized, the battery charger of a portable device can be miniaturized.

The photocoupler having any one of the first to tenth characteristics is characterized as an eleventh characteristic in that an inner side part of a resin seal part of the one package including a space in which the light signal is transmitted from the light-emitting element to the light-receiving element is formed of a transparent resin transmitting light having a range of a sensitivity wavelength of the light-receiving element, and an outer side part of the resin seal part surrounding the inner side part is formed of an opaque resin not transmitting the light having the range of the sensitivity wavelength of the light-receiving element.

According to the photocoupler having the eleventh characteristic, the light-emitting element and the light-receiving control integrated circuit are sealed in one package such that they are electrically insulated from each other by the seal resin and the light signal can be transmitted from the light-emitting element to the light-receiving element, and unnecessary light from the outside is prevented from entering the light-receiving element.

A switching power supply circuit according to the present invention to achieve the above object is characterized as a first characteristic by comprising: the photocoupler having any one of the above characteristics; a transformer having a primary winding and a secondary winding; a voltage step-down element for stepping down a DC voltage inputted to one end of the primary winding to be inputted to one of the pair of power supply terminals of the light-receiving control integrated circuit of the photocoupler; a switching operating transistor provided between the other end of the primary winding and the other side of the pair of power supply terminals of the light-receiving control integrated circuit of the photocoupler and turned on/off by the switching control signal outputted from the output terminal of the light-receiving control integrated circuit; a rectifying and smoothing circuit provided between both ends of the secondary winding; and a voltage detecting element or a voltage detecting circuit for detecting an output voltage of the rectifying and smoothing circuit to be inputted to the light-emitting element as the output voltage information.

The switching power supply circuit having the first characteristic according to the present invention is characterized as a second characteristic in that the voltage step-down element comprises at least one of a resistor element, a depression type FET having a gate connected to the other side of the pair of power supply terminals of the light-receiving control integrated circuit, and a transistor whose base or gate is supplied with a middle voltage between one end of the primary winding and the other side of the pair of power supply terminals of the light-receiving control integrated circuit.

According to the switching power supply circuit having the first or second characteristic, the operational effect of the photocoupler having the first characteristic can be achieved, so that since the number of components of the switching power supply circuit is reduced, the component mounting area can be reduced, and the speed of the switching operation is increased, the peripheral components such as the transformer, diode and capacitor of the switching power supply circuit are miniaturized, and since the photodiode is used as the light-receiving element, the drive current can be low, the power loss in the light-receiving element can be considerably suppressed, and the power consumption can be low as compared with the conventional case where the phototransistor is used as the light-receiving element, and since the photodiode is used as the light-receiving element, and the amplifier circuit for amplifying the output signal of the light-receiving element is provided at its subsequent stage, and they are made into one chip, the light-receiving sensitivity of the light-receiving element is considerably improved as compared with the conventional phototransistor, so that the drive current on the side of the light-emitting element can be small, and the power consumption can be low. As a result, the first to fifth problems of the conventional switching power supply circuit can be all solved.

Especially, in the case where the photocoupler having the second characteristic is used, even when the fluctuation of the current consumption of the part except for the current control transistor and the current control circuit of the light-receiving control integrated circuit is large, and the high DC voltage inputted to the primary side of the switching power supply circuit is stepped down by the high resistance element to be supplied as the power supply voltage of the light-receiving control integrated circuit, since the one-chip light-receiving control integrated circuit can be produced through the low and middle voltage process, the production cost can be lowered. Furthermore, since the one-chip light-receiving control integrated circuit can be produced through the low and middle voltage process, and the high DC voltage inputted to the primary side of the switching power supply circuit can be stepped down by the high resistance element to be supplied as the power supply voltage of the light-receiving control integrated circuit, the power supply by use of the tertiary winding of the transformer in the conventional examples 2 and 3 is not needed, and the tertiary winding and its peripheral components such as a capacitor and a diode for rectifying and smoothing are not needed.

### BRIEF DESCRIPTION OF THE DRAWINGS

FIG. 1 is a circuit diagram showing a schematic circuit configuration of a photocoupler and a switching power supply circuit according to a first embodiment of the present invention;

FIG. 2 is a sectional view schematically showing a sectional structure of a package in which a light-emitting element and a light-receiving control integrated circuit of the photocoupler shown in FIG. 1 are sealed with two kinds of resins;

FIG. 3 is a sectional view schematically showing the light-receiving element in the light-receiving control integrated circuit shown in FIG. 1;

FIG. 4 is a view showing one example of a chip layout of the light-receiving control integrated circuit shown in FIG. 1;

FIG. 5 is a view showing another example of the chip layout of the light-receiving control integrated circuit shown in FIG. 1;

FIG. 6 is a circuit diagram showing a schematic circuit configuration of a light-receiving control integrated circuit in a second embodiment of the photocoupler according to the present invention;

FIG. 7 is a sectional view schematically showing a sectional structure of a light-receiving element in a light-receiving control integrated circuit in a third embodiment of the photocoupler according to the present invention;

FIG. 8 is a sectional view showing a positional relation among a first lead frame, a second lead frame, a light-emitting element, and a light-receiving control integrated circuit in a package in the third embodiment of the photocoupler according to the present invention;

FIG. 9 is a sectional view showing another positional relation among the first lead frame, the second lead frame, the light-emitting element, and the light-receiving control integrated circuit in the package in the third embodiment of the photocoupler according to the present invention;

FIG. 10 is a sectional view showing still another positional relation among the first lead frame, the second lead frame, the light-emitting element, and the light-receiving control integrated circuit in the package in the third embodiment of the photocoupler according to the present invention;

FIG. 11 is a circuit diagram showing a schematic circuit configuration in a first other embodiment of the photocoupler and the switching power supply circuit according to the present invention:

FIG. 12 is a circuit diagram showing a schematic circuit configuration in a second other embodiment of the photocoupler and the switching power supply circuit according to the present invention:

FIG. 13 is a circuit diagram showing a schematic circuit configuration in a third other embodiment of the photocoupler and the switching power supply circuit according to the present invention:

FIG. 14 is a circuit diagram showing a schematic circuit configuration in a fourth other embodiment of the photocoupler and the switching power supply circuit according to the present invention:

FIG. 15 is a circuit diagram showing a circuit configuration of a first conventional example of a switching power supply circuit;

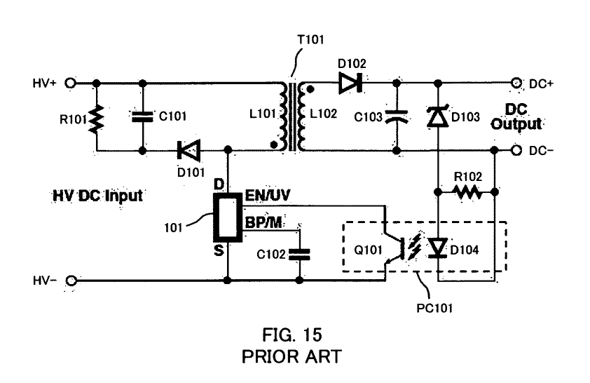

FIG. 16 is a circuit diagram showing a circuit configuration of a second conventional example of the switching power supply circuit; and

FIG. 17 is a circuit diagram showing a circuit configuration of a third conventional example of the switching power supply circuit.

### DESCRIPTION OF THE PREFERRED EMBODIMENTS

Next, embodiments of a photocoupler and a switching power supply circuit provided with the photocoupler according to the present invention will be described with reference to the drawings.

### First Embodiment

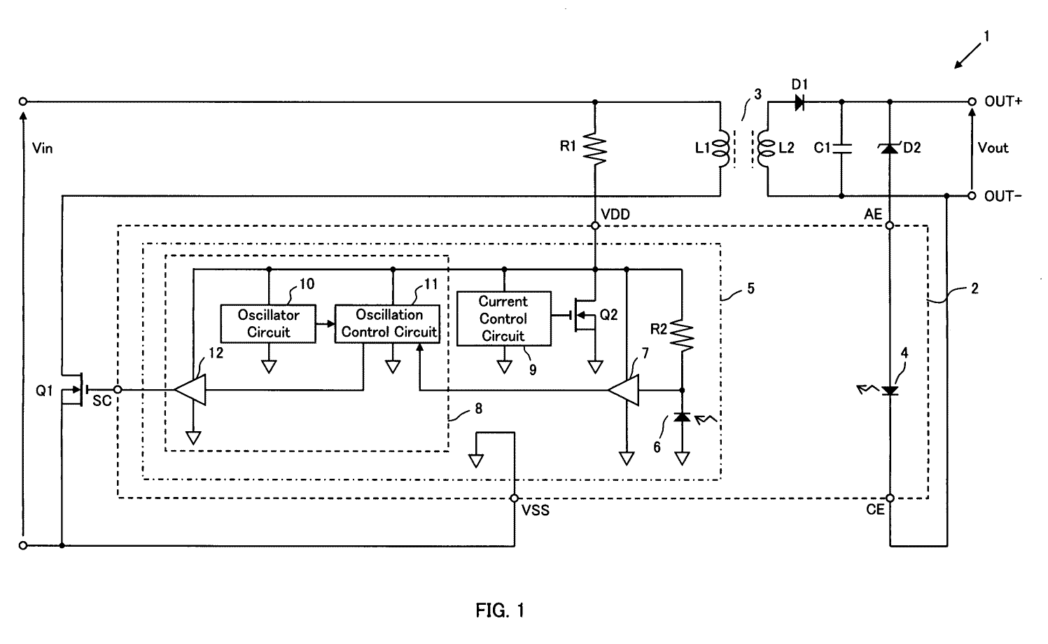

As shown in FIG. 1, a switching power supply circuit 1 according to a first embodiment of the present invention includes a photocoupler 2 sealed in one package, a transformer 3 composed of a primary wiring L1 and a secondary wiring L2, a resistor R1 for stepping down a DC input voltage Vin inputted to one end of the primary wiring L1 to be supplied to the photocoupler 2, a transistor Q1 for performing a switching operation of a current flowing in the primary wiring L1, a diode D1 having an anode connected to one end of the secondary wiring L2, a capacitor C1 connected between a cathode of the diode D1 and the other end of the secondary wiring L2, and a zener diode D2 for detecting a DC output voltage Vout outputted to both ends of the capacitor C1. The switching power supply circuit 1 is composed of seven components in total such as the photocoupler 2, the resistor R1, the transistor Q1, the transformer 3, the diode D1, the capacitor C1, and the zener diode D2.

In addition, when the switching power supply circuit 1 is configured as an AC/DC adaptor, although it is necessary to further provide a full-wave rectifying diode bridge circuit and a smoothing capacitor at a previous stage of the primary winding L1, since the switching power supply circuit 1 is not limited to application as the AC/DC adaptor but can be used as an DC/DC converter for a DC voltage outputted from a DC power supply, the diode bridge circuit and the smoothing capacitor are not shown on purpose. When the switching power supply circuit 1 is configured as the AC/DC adaptor for the commercial AD power supply, the DC input voltage Vin is about 141V according to national application in which the AC voltage is 100V. In addition, in the case of the AC power supply other than the commercial AC power supply (in-car AC power supply, for example), the AC voltage is lower than 100V and the DC input voltage Vin is also lower.

The photocoupler 2 is composed of two chips such as a light-emitting element 4 composed of a light-emitting diode and a light-receiving control integrated circuit 5 that are sealed in one package. In addition, the light-receiving control integrated circuit 5 is configured such that a light-receiving element 6 composed of a photodiode, a current adjusting resistor R2 for the light-receiving element 6, an amplifier circuit 7 for amplifying an output signal of a light-receiving circuit including the current adjusting resistor R2 and the light-receiving element 6, a switching control circuit 8 for controlling on/off of the transistor Q1 for the switching operation, a current control transistor Q2, and a current control circuit 9 for controlling a current flowing in the current control transistor are integrated in one chip.

The switching control circuit 8 is composed of an oscillator circuit 10, an oscillation control circuit 11 for controlling the oscillation of the oscillator circuit 10 based on the output of the amplifier circuit 7, and an output driver circuit 12 for driving a switching control signal outputted from the oscillation control circuit 11 and output it to the gate of the transistor Q1. In addition, since the oscillation control circuit 11 can be implemented with a well-known circuit configuration such as a logic circuit, the circuit configuration of the switching control circuit 8 will not be described in detail.

The current control transistor Q2 is a transistor for controlling a momentary current consumption of the light-receiving control integrated circuit 5 and provided between a pair of power supply terminals (VDD and VSS). The current control transistor Q2 controls a current amount so as to prevent fluctuation in total current consumed by the amplifier circuit 7, the switching control circuit 8, and the current control circuit 9. According to this embodiment, since the resistor R1 for high voltage is provided between the DC input voltage Vin and the power supply terminal VDD, the fluctuation in current consumption of the light-receiving control integrated circuit 5 appears as voltage fluctuation of the power supply terminal VDD, and the current control circuit 9 adjusts the current amount by controlling the gate voltage of the current control transistor Q2 so that the voltage of the power supply terminal VDD falls within a constant range. More specifically, the voltage of the power supply terminal VDD is controlled to be less than or equal to the withstand voltage of the light-receiving control integrated circuit 5 and within the range of operating voltage so that the higher the voltage of the power supply terminal VDD is, the more the current amount of the current control transistor Q2 is increased. As a result, the current consumption of the light-receiving control integrated circuit 5 is prevented from fluctuating regardless of the operation state of the light-receiving control integrated circuit 5, so that the voltage of the power supply terminal VDD is limited within the certain range. As a result, according to this embodiment, the light-receiving control integrated circuit 5 can be produced through a semiconductor production process at the middle and low voltage of about 20V. Since the current control circuit 9 can be implemented with a well-known circuit configuration for performing feedback control over the voltage value applied to the gate of the current control transistor Q2, based on a differential value between the voltage of the power supply terminal VDD and a predetermined reference voltage, its circuit configuration will not be described in detail.

Next, a setting example of the resistor R1 will be described. The current consumption of the light-receiving control integrated circuit 5 having the light-receiving element 6 composed of the photodiode can be 0.5 to 1 mA at the time of operation of 100 kHz except for the current consumption of the current control transistor Q2. In the case where the product of 2SK2998 manufactured by Toshiba is used as the transistor Q1 for the switching operation, since the gate capacity needs to be about 75 pF and the gate voltage in the on state needs to be about 10V, when the switching operation is performed at 100 kHz, the charge/discharge current of the gate capacity is 75 μA. Therefore, the current consumption except for the current control transistor Q2 of the light-receiving control integrated circuit 5 is 0.575 to 1.075 mA. When it is assumed that the current control transistor Q2 is controlled such that the fluctuation of above current consumption is offset, within a fluctuation range of 0.125 to 0.525 mA in view of the margin, the total current consumption of the light-receiving control integrated circuit 5, that is, the current flowing in the resistor R1 has a constant value of 1.1 mA. When it is assumed that the DC input voltage Vin of the switching power supply circuit 1 is 141V, and the applied voltage to the power supply terminal VDD of the light-receiving control integrated circuit 5 is 15V, the resistance value of the resistor R1 is (141V−15V)/1.1 mA=114.5 kΩ. In addition, the total current consumption of the light-receiving control integrated circuit 5 is not always controlled to have the constant value, and there is no problem as long as the fluctuation range of the applied voltage to the power supply terminal VDD due to the variation in the total current consumption is not more than the withstand voltage and not less than the minimum operating voltage of the light-receiving control integrated circuit 5.

Next, the operation of the switching power supply circuit 1 will be described. When the DC input voltage Vin is applied to the switching power supply circuit 1, the power supply voltage is applied to the power supply terminal VDD of the light-receiving control integrated circuit 5 through the resistor R1, and the light-receiving control integrated circuit 5 begins to operate, while the power supply voltage in the power supply terminal VDD is kept constant, and the oscillation circuit 10 of the switching control circuit 8 begins to oscillate. The duty ratio of the oscillation signal is controlled by the oscillation control circuit 11, and the signal is converted to have an appropriate amplitude level by the output driver circuit 12 as the switching control signal, and inputted to the gate of the switching operating transistor Q1. Meanwhile, the DC input voltage Vin is applied to the drain of the transistor Q1 through the primary winding L1, and the transistor Q1 performs the switching operation so as to be repeatedly turned on and off in response to the switching control signal inputted to its gate. As a result, the current flows in the primary winding L1 intermittently, an AC voltage is generated at both ends of the secondary winding L2, the AC voltage is rectified by the diode D1 and smoothed by the capacitor C1, and the DC output voltage Vout is outputted from a pair of output terminals OUT+ and OUT−.

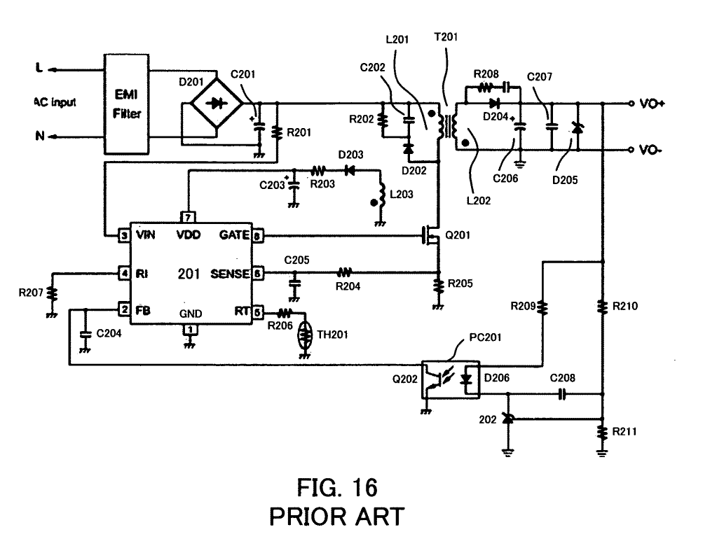

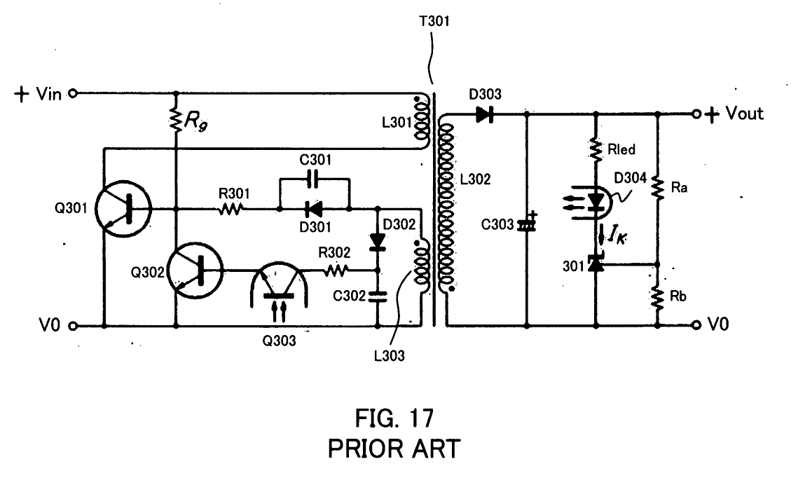

Since the zener diode D2 is connected so as to be inversely-biased between the output terminals OUT+ and OUT−, when the output voltage Vout exceeds the breakdown voltage of the zener diode D2, the current flows in the zener diode D2 and the light-emitting element 4 is turned on and outputs a light signal showing that the output voltage Vout exceeds the breakdown voltage of the zener diode D2. When the light-receiving element 6 receives the light signal, the signal is converted to an electric signal and amplified by the amplifier circuit 7 and inputted to the oscillation control circuit 11. Since the oscillation control circuit 11 controls the switching control signal so that the transistor Q1 is turned off, based on the output of the amplifier circuit 7, the switching operation stops and a current does not flow in the primary winding L1, so that the AC voltage is not generated at both ends of the secondary winding L2. As a result, since the output voltage Vout is lowered and the current does not flow in the zener diode D2, the light-emitting element 4 is turned off and the oscillation control circuit 11 outputs the switching control signal to the gate of the transistor Q1 again through the output driver circuit 12, so that the transistor Q1 begins the switching operation again. By repeating the above operations, the output voltage between the output terminals OUT+ and OUT− is kept constant. In addition, although the zener diode D2 functions as the voltage detecting element of the output voltage Vout in the above operation, the output voltage Vout may be detected such that the divided voltage value is detected by the voltage detecting IC like the circuit configurations of the conventional examples 2 and 3 shown in FIGS. 16 and 17, respectively, instead of using the single voltage detecting element such as the zener diode D2.

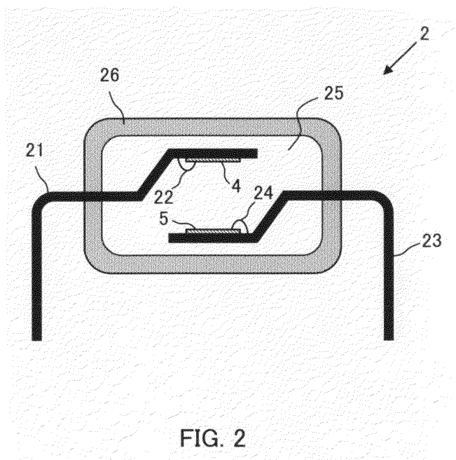

Next, the structure of the photocoupler 2 will be described. FIG. 2 is a sectional view schematically showing the sectional structure of the package of the photocoupler 2 in which the light-emitting element 4 and the light-receiving control integrated circuit 5 are sealed with two kinds of resins.

As shown in FIG. 2, the light-emitting element 4 is set on a first lead frame 21, and an anode electrode AE and a cathode electrode CE of the light-emitting element 4 are electrically connected to the corresponding lead terminals AE and CE of the first lead frame 21 by a bonding wire 22, respectively. The light-receiving control integrated circuit 5 is set on a second lead frame 23, and the power supply terminals VDD and VSS and an output terminal SC for outputting the switching control signal are electrically connected to the corresponding lead terminals VDD, VSS, and SC of the second lead frame 23 by a bonding wire 24, respectively.

The first lead frame 21 and the second lead frame 23 are provided such that their chip mounted surfaces are apart from each other in a thickness direction in the package, and the light-emitting element 4 and the light-receiving control integrated circuit 5 are positioned so as to be opposed to each other in the thickness direction so that the light signal outputted from the light-emitting element 4 can be received by the light-receiving element 6 of the light-receiving control integrated circuit 5.

As shown in FIG. 2, the inner side part of the resin seal part of the package including the space in which the light signal is transmitted from the light-emitting element 4 to the light-receiving control integrated circuit 5 is formed of a transparent epoxy resin 25 that transmits light having the sensitivity wavelength range of the light-receiving element 6, and the outer side part of the resin seal part surrounding the inner side part is formed of a black epoxy resin 26 that does not transmit the light having the sensitivity wavelength range of the light-receiving element 6. In addition, the sensitivity wavelength range of the light-receiving element 6 is defined by the bandgap energy of a semiconductor material of the photodiode of the light-receiving element 6, while the bandgap energy of a semiconductor material of the light-emitting element 4 is set so that the emission wavelength of the light-emitting element 4 conforms to the sensitivity wavelength range of the light-receiving element 6. In addition, when the semiconductor material is a ternary compound semiconductor such as GaAlAs, the bandgap energy thereof is determined by the composition ratio of GaAlAs.

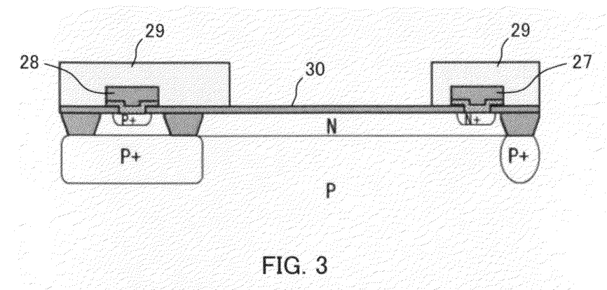

FIG. 3 is a schematic view showing the sectional structure of the light-receiving element 6 in the light-receiving control integrated circuit 5. As shown in FIG. 3, the light-receiving control integrated circuit 5 is formed on a P type substrate, and impurity diffused regions P+, N+, and N of the light-receiving element 6 are formed by ion implantation in a general semiconductor production step. With a metal wiring layer of the light-receiving control integrated circuit 5, when a positive potential is supplied to a cathode electrode 27 connected to the N type impurity diffused region from the power supply of the light-receiving control integrated circuit 5 through a resistor or a constant current circuit, and the ground potential is supplied to an anode electrode 28 connected to the P type impurity diffused region to provide the inversely-biased state, and when the light signal from the light-emitting element 4 reaches the PN junction part through the opening of a protective insulation film 29 formed on the cathode electrode 27 and the anode electrode 28, and a reflection protecting film 30, a current flows from the cathode electrode 27 to the anode electrode 28, so that the potential of the cathode electrode 27 is changed. When the cathode electrode 27 is connected to the input of the amplifier circuit 7 through the metal wiring layer of the light-receiving control integrated circuit 5, the potential variation of the cathode electrode 27 is amplified and detected by the amplifier circuit 7. In addition, an incident path of the light signal from the opening part of the protective insulation film 29 to the PN junction corresponds to a light-receiving part.

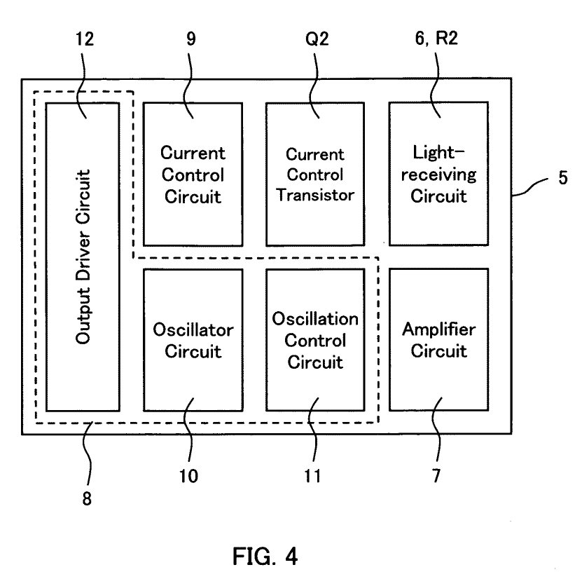

Next, a chip layout of the light-receiving control integrated circuit 5 will be described with reference to FIG. 4. As described above, when the switching power supply circuit 1 is configured as the AC/DC adaptor for the commercial AC power supply, since the DC input voltage Vin is about 141V, intense noise is generated due to the switching operation of the transistor Q1. The noise appears in the gate through the gate and drain capacity of the transistor Q1 and reaches the output driver circuit 12 of the switching control circuit 8. According to the conventional photocoupler using the phototransistor as the light-receiving element, since a signal current of the light-receiving element is large (about 1 mA), noise resistance is high and an erroneous operation is hardly generated. Meanwhile, according to this embodiment, since the photodiode is used for the light-receiving element 6, a signal current is small (about 10 μA), the photocoupler is likely to be affected by the noise and the erroneous operation is likely to be generated. In this respect, according to this embodiment, in order to improve the noise resistance of the light-receiving element 6 substantially, a light-receiving circuit part composed of the light-receiving element 6 and the current adjusting resistor R2 and the amplifier circuit 7 is apart from the output driver circuit 12 such that they are arranged at opposed two sides. According to such chip layout, the noise transmitted to the output driver circuit 12 hardly enters the light-receiving circuit part. In addition, the current control transistor Q2, the current control circuit 9, the oscillator circuit 10, and the oscillation control circuit 11 are arranged in the center of the chip between the output driver circuit 12 and the light-receiving circuit part.

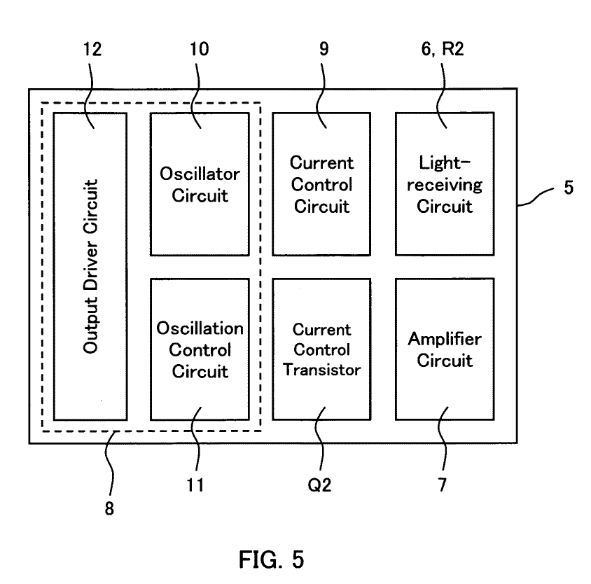

According to a chip layout of the light-receiving control integrated circuit 5 shown in FIG. 4, although the circuit arrangement focuses on the flow of the signal from the amplifier circuit 7 to the oscillation control circuit 11 and the oscillator circuit 10, when the current control transistor Q2 and the current control circuit 9 having low impedance are arranged between the output driver circuit 12 and the light-receiving circuit part to isolate both circuits, the noise is further prevented from entering the light-receiving part as shown in FIG. 5.

### Second Embodiment

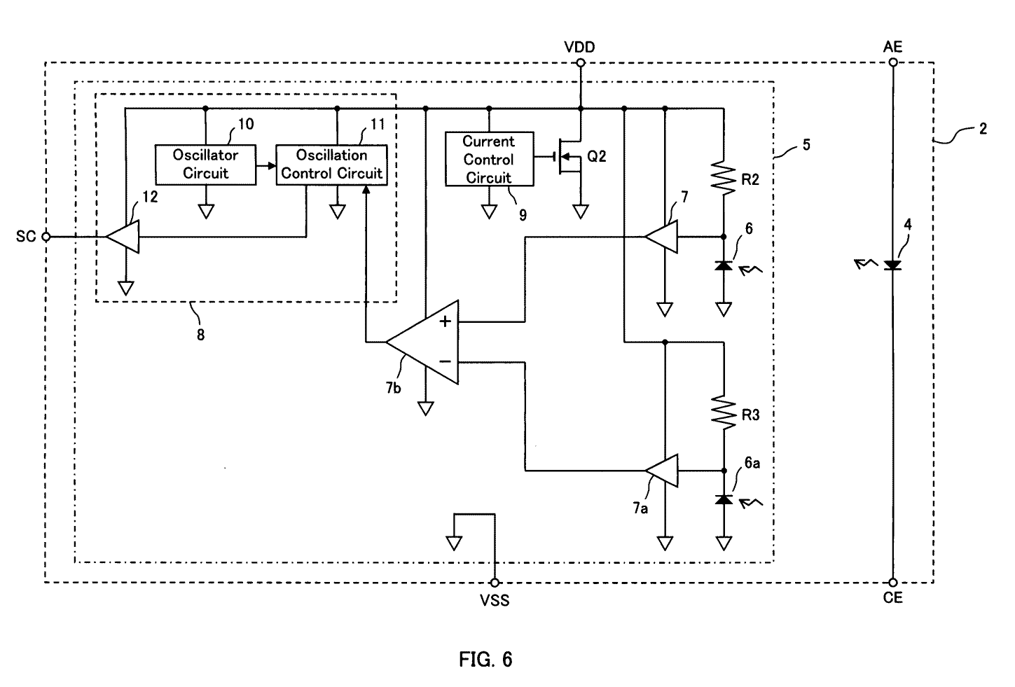

Next, the switching power supply circuit 1 according to a second embodiment of the present invention will be described. The switching power supply circuit 1 according to the second embodiment differs from that of the first embodiment in a circuit configuration of the light-receiving control integrated circuit 5 in the photocoupler 2. Since the configuration and the package structure of the photocoupler 2, and the circuit configuration of the switching power supply circuit 1 having the photocoupler 2 are the same as those in the first embodiment, the same description will be omitted. The circuit configuration of the light-receiving control integrated circuit 5 according to the second embodiment will be described with reference to FIG. 6 hereinafter.

According to this embodiment, the light-receiving control integrated circuit 5 is composed of light-receiving elements 6 and 6a (first light-receiving element 6 and second light-receiving element 6a) constructed of a pair of photodiodes, current adjusting resistors R2 and R3 (first current adjusting resistor R2 and second current adjusting resistor R3) for the light-receiving elements 6 and 6a, the first amplifier circuit 7 for amplifying an output signal of a first light-receiving circuit including the first current adjusting resistor R2 and the first light-receiving element 6, a second amplifier circuit for amplifying an output signal of a second light-receiving circuit including the second current adjusting resistor R3 and the second light-receiving element 6a, a differential amplifier circuit 7b for amplifying the difference between the output signals of the first amplifier circuit 7 and the second amplifier circuit 7a, the switching control circuit 8 for controlling the on/off of the switching operating transistor Q1, the current control transistor Q2, and the current control circuit 9 for controlling the current flowing in the current control transistor, which are integrated in one chip. Therefore, the configuration of the light-receiving circuit part composed of the light-receiving element, the load circuit, and the amplifier circuit is different from that in the first embodiment. However, the circuit configuration of the switching control circuit 8, the current control transistor Q2, and the current control circuit 9 is the same as those in the first embodiment. Here, it is to be noted that unlike the first embodiment, the oscillation control circuit 11 of the switching control circuit 8 controls the oscillation of the oscillator circuit 10 not based on the output of the amplifier circuit 7 but based on the output of the differential amplifier circuit 7b.

Although the pair of light-receiving elements 6 and 6a is composed of the same photodiode having the same light-receiving characteristics, only the upper part of the PN junction in the first light-receiving element 6 is not covered with the protective insulation film 29 and open as shown in FIG. 3 so as to receive the light signal outputted from the light-emitting element 4 similar to the light-receiving element 6 in the light-receiving control integrated circuit 5 in the first embodiment, while the upper part of the PN junction of the second light-receiving element 6a is covered with a metal layer and the like so as not to receive the light signal outputted from the light-emitting element 4. In addition, since the second light-receiving element 6a does not receive the light signal outputted from the light-emitting element 4, the light-receiving elements 6 and 6a only need to have the same dark current characteristics when they do not receive the light.

According to the above circuit configuration of the light-receiving control integrated circuit 5, when the light signal is outputted from the light-emitting element 4, it is received and converted to an electric signal by the first light-receiving element 6 and amplified by the first amplifier circuit 7. Meanwhile, since the second light-receiving element 6a is shielded, it does not receive the light signal, but the same electric signal as that outputted when the first light-receiving element 6 does not receive the light signal is outputted and amplified by the second amplifier circuit 7a. The differential amplifier circuit 7b receives both output signals of the first amplifier circuit 7 and the second amplifier circuit 7a as differential inputs and amplifies their difference. Therefore, even when the light signal from the light-emitting element 4 is weak, the light signal can be detected with high sensitivity by the differential amplifier circuit 7b. As a result, the drive current of the light-emitting element 4 can be further reduced and the current consumption can be lowered and since the differential amplifier circuit 7b is used, even when the common mode noise is superimposed on the two of the first light-receiving circuit and the second light-receiving circuit, the common mode noise is cancelled by the differential amplifier circuit 7b, so that the noise resistance of the light-receiving element and the amplifier circuit can be improved.

### Third Embodiment

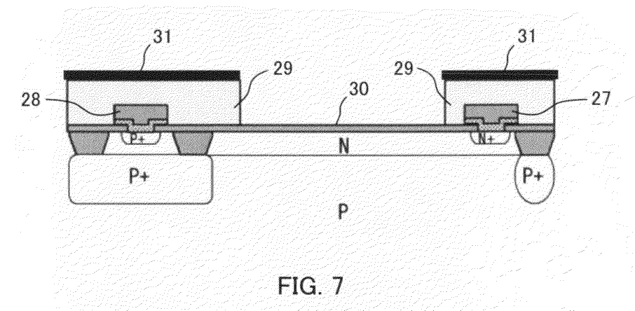

Next, the switching power supply circuit 1 according to a third embodiment of the present invention will be described. The switching power supply circuit 1 according to the third embodiment is a variation of the first embodiment and the second embodiment, and an element structure of the light-receiving control integrated circuit 5 in the photocoupler 2 is different from those in the first embodiment and the second embodiment. Since the configuration and the package structure of the photocoupler 2, the circuit configuration of the light-receiving control integrated circuit 5, and the circuit configuration of the switching power supply circuit 1 having the photocoupler 2 are the same as those in the first embodiment or the second embodiment, the same description will be omitted. The element structure of the light-receiving control integrated circuit 5 according to the third embodiment will be described with reference to FIG. 7 hereinafter. FIG. 7 is a sectional view schematically showing the sectional structure of the light-receiving element 6 in the light-receiving control integrated circuit 5 according to the third embodiment.

Since there is a case where a voltage higher than usual is applied between the primary side circuit and the secondary side circuit in the switching power supply circuit and it is required to reinforce the insulation between the primary and secondary circuits, according to this embodiment, dielectric strength is enhanced between the primary and secondary circuits of the photocoupler 2, that is, between the light-emitting element 4 and the light-receiving control integrated circuit 5. More specifically, when the high voltage is applied to the sides of the light-emitting element 4 and the light-receiving control integrated circuit 5, since an intense electric field is generated between the light-emitting element 4 and the light-receiving control integrated circuit 5, and the surface of the light-receiving control integrated circuit 5 is electrically charged, and the polarity is inversed, so that the light-receiving element 6 of the light-receiving control integrated circuit 5 could perform an erroneous operation. Thus, in order to prevent such erroneous operation, a metal shield film 31 is provided on the surface of the protective insulation film 29 of the light-receiving control integrated circuit 5 to prevent the above charging as shown in FIG. 7. In addition, since the metal shield film 31 is not provided in the opening of the protective insulation film 29, the light signal from the light-emitting element 4 can be inputted to the PN junction part of the light-receiving element 6 through the opening and the reflection preventing film 30.

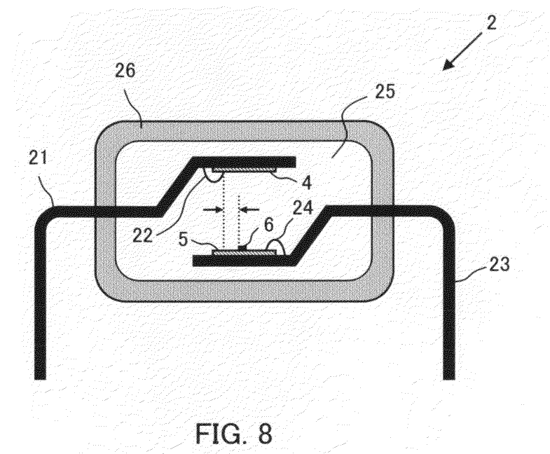

In addition, as a method for enhancing the dielectric strength between the light-emitting element 4 and the light-receiving control integrated circuit 5, instead of the method in which the metal shield film 31 is provided on the protective insulation film 29 of the light-receiving control integrated circuit 5 shown in FIG. 7 or in addition thereto, it is also preferable to adjust the arrangements of the first lead frame 21, the second lead frame 23, and the light-emitting element 4, and the light-receiving control integrated circuit 5 in the package of the photocoupler 2 as shown in FIGS. 8 to 10.

According to an example shown in FIG. 8, even when the intense electric field is generated between the light-emitting element 4 and the light-receiving control integrated circuit 5, the effect of the intense electric field from the bonding wire 22 on the light-receiving element 6 can be alleviated by adjusting the arrangement of the first lead frame 21, the second lead frame 23, the light-emitting element 4 and the light-receiving control integrated circuit 5 so that the bonding wire 22 on the first lead frame may not be opposed to the light-receiving element 6 of the light-receiving control integrated circuit 5 on the second lead frame 23 in the thickness direction of the package.

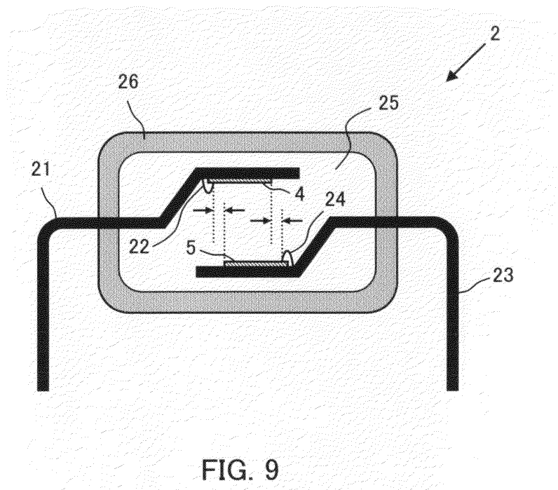

Furthermore, according to an example shown in FIG. 9, even when the intense electric field is generated between the light-emitting element 4 and the light-receiving control integrated circuit 5, the effect of the intense electric field from the bonding wire 22 on the light-receiving element 6 can be alleviated and the effect of the intense electric field from the bonding wire 24 on the light-emitting element 4 can be alleviated by bringing the light-emitting element 4 on the first lead frame 21 close to the bonding wire 22, and bringing the light-receiving control integrated circuit 5 on the second lead frame 23 close to the bonding wire 24 so that the bonding wire 22 on the first lead frame 21 and the light-receiving control integrated circuit 5 on the second lead frame 23 are not opposed to each other in the thickness direction of the package, and so that the bonding wire 24 on the second lead frame 23 and the light-emitting element 4 on the first lead frame 21 are not opposed to each other in the thickness direction of the package.

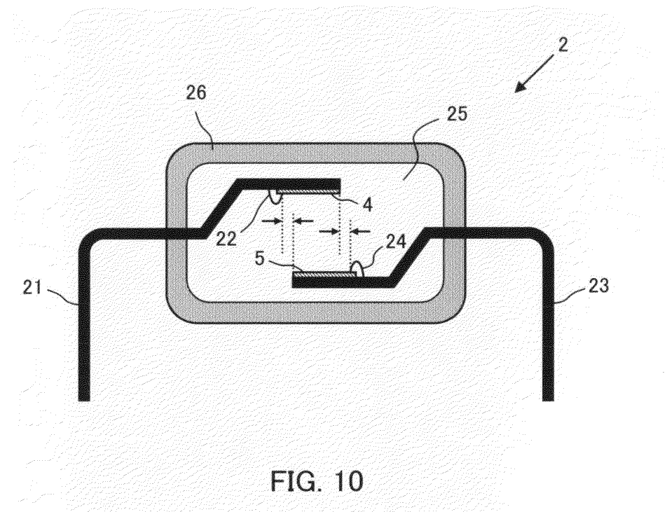

Still furthermore, according to an example shown in FIG. 10, even when the intense electric field is generated between the light-emitting element 4 and the light-receiving control integrated circuit 5, the effect of the intense electric field from the bonding wire 22 on the light-receiving element 6 can be alleviated and the effect of the intense electric field from the bonding wire 24 on the light-emitting element 4 can be alleviated by shifting each of the lead frames 21 and 23 to the side of the black epoxy resin 26 in which each of them is fixed, that is, by arranging the first lead frame 21 and the second lead frame 23 so as to be apart from the bonding wire 24 and the bonding wire 22, respectively in a direction parallel to the chip mounted surface, so that the bonding wire 22 on first lead frame 21 is not opposed to the second lead frame 23 in the thickness direction of the package, and the bonding wire 24 on the second lead frame 23 is not opposed to the first lead frame 21 in the thickness direction of the package.

### Other Embodiments

A description will be made of embodiments other than the first to third embodiments.

(1) Although the semiconductor material of the light-emitting element 4 is not limited to a specific material as long as the material is adapted to the sensitivity wavelength range of the light-receiving element 6 in the above embodiments, it is preferable to use a light-emitting diode composed of GaAlAs as the light-emitting element 4, in order to further miniaturize the transformer 3, the diode D1, and the capacitor C1 serving as peripheral components of the switching power supply circuit 1 and to prevent the fluctuation of the output voltage Vout, so that switching speed is improved.

When the light-emitting diode formed of GaAs is used as the light-emitting element 4, each of rising time and falling time of the signal combined with the phototransistor is about 5 μs, and a practical frequency is about 100 kHz. Meanwhile, when the light-emitting diode formed of GaAlAs is used, since both rising time and falling time can be shortened to 0.1 μs, a practical frequency can be as fast as 5 MHz. As a result, since the transformer that has been an obstacle to the miniaturization of the switching power supply circuit 1 is further miniaturized, an electric charger for a portable device can be miniaturized.

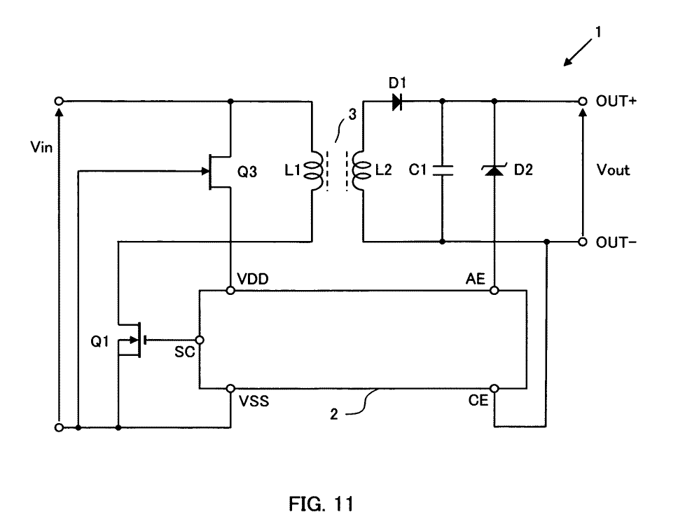

(2) Although the high resistance resistor R1 is used as the voltage step-down element to step down the DC input voltage Vin and supply the power to the photocoupler 2 in the above embodiments, it is also preferable to use a depression type high voltage FET (Field Effect Transistor) Q3 as shown in FIG. 11 instead of the resistor R1. According to the transistor Q3, its drain is connected to one end of the primary winding L1, and its source is connected to the power supply terminal VDD of the photocoupler 2, and its gate is connected to the other power supply terminal VSS of the photocoupler 2 so that the ground voltage of 0V is constantly applied to the gate. When the transistor Q3 is used, the terminal voltage of the power supply terminal VDD of the photocoupler 2 is stabilized, and the start time of the switching power supply circuit 1 can be shortened. This embodiment is the same as the above embodiments except that the resistor R1 is replaced with the transistor Q3. A description will be made of a power supply operation to the light-receiving control integrated circuit 5 in the switching power supply circuit 1 shown in FIG. 11.

Under the condition that the terminal voltage of the power supply terminal VDD is 0V in the initial state, when the DC input voltage Vin is inputted to one end of the primary winding L1, since the gate voltage and the source voltage of the transistor Q3 are 0V, and the transistor Q3 is the depression type, a drain current begins to flow from the drain to the source of the transistor Q3. When the terminal voltage of the power supply terminal VDD is raised due to this drain current, since the source voltage of the transistor Q3 is raised, the voltage between the gate and the source viewed from the source of the transistor Q3 is gradually lowered and when the voltage between the gate and the source reaches the pinch-off voltage of the transistor Q3, the transistor Q3 is turned off and the drain current does not flow. Thus, the terminal voltage of the power supply terminal VDD is not raised beyond the pinch-off voltage of the transistor Q3, so that the voltage is fixed to a voltage when the drain current less than or equal to the pitch-off voltage becomes equal to the current consumption of the light-receiving control integrated circuit 5.

In addition, as compared with the case where the DC input voltage Vin is lowered by the resistor R1 like in the above embodiment, the starting current can be increased at the initial stage when the drain current begins to flow, by increasing the drain current of the transistor Q3 so that the rising speed of the terminal voltage of the power supply terminal VDD of the light-receiving control integrated circuit 5 is increased, and the starting time of the switching power supply circuit 1 can be shortened.

In addition, as described above, since the terminal voltage of the power supply terminal VDD does not rise beyond the pinch-off voltage of the transistor Q3, even when the current consumption of the light-receiving control integrated circuit 5 fluctuates, the terminal voltage of the power supply terminal VDD is prevented from fluctuating as compared with the case where the DC input voltage Vin is stepped down by the resistor R1. Thus, although the current control transistor Q2 and the current control circuit 9 are provided in the light-receiving control integrated circuit 5 to prevent the current consumption of the light-receiving control integrated circuit 5 from fluctuating and to stabilize the terminal voltage of the power supply terminal VDD in the above embodiments, in the case where the fluctuation of the terminal voltage of the power supply terminal VDD is within the operating voltage range of the light-receiving control integrated circuit 5, the circuit for stabilizing the terminal voltage of the power supply terminal VDD can be omitted.

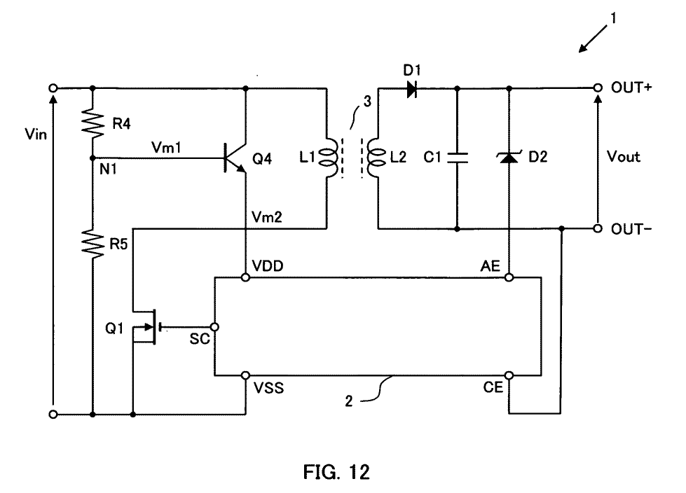

(3) Although the high resistance resistor R1 is used as the voltage step-down element to step down the DC input voltage Vin to supply the power to the photocoupler 2 in the above embodiments, as shown in FIG. 12, it is also preferable to use an NPN type bipolar transistor Q4 instead of the resistor R1. According to the transistor Q4, its collector is connected to one end of the primary winding L1, its emitter is connected to the power supply terminal VDD of the photocoupler 2, and its base is connected to a middle point N1 between voltage dividing resistors R4 and R5 connected between one end of the primary winding L1 and the other power supply terminal VSS of the photocoupler 2, so that a middle voltage Vm1 provided by multiplying the DC input voltage Vin by the voltage dividing ratio of the voltage dividing resistors R4 and R5 is applied to the base. When the transistor Q4 is used, the terminal voltage of the power supply terminal VDD of the photocoupler 2 is stabilized and the starting time of the switching power supply circuit 1 can be shortened. This embodiment is the same as the above embodiments except that the resistor R1 is replaced with the transistor Q4 and the voltage dividing resistors R4 and R5 are added. A description will be made of a power supply voltage supply operation to the light-receiving control integrated circuit 5 in the switching power supply circuit 1 shown in FIG. 12 hereinafter.

When the DC input voltage Vin is inputted to one end of the primary winding L1, the middle voltage Vm1 provided by multiplying the DC input voltage Vin by the voltage dividing ratio of the voltage dividing resistors R4 and R5 is applied to the base of the transistor Q4, and since the emitter voltage is 0V in the initial state when the terminal voltage of the power supply terminal VDD is 0V, the collector current begins to flow from the collector to the emitter of the transistor Q4. When this collector current allows the terminal voltage of the power supply terminal VDD to rise, since the emitter voltage of the transistor Q4 rises, the voltage between the base and emitter viewed from the emitter of the transistor Q4 gradually falls and when the voltage between the base and the emitter comes close to about 0.7V, the base current of the transistor Q4 is cut off and the collector current does not flow. Thus, the terminal voltage of the power supply terminal VDD does not rise beyond the middle voltage Vm2 lower than the middle voltage Vm1 by about 0.7V, and fixed to the voltage when the collector current becomes equal to the current consumption of the light-receiving control integrated circuit 5, which is not more than the middle voltage Vm2. In addition, the transistor Q4 may be a high voltage N type MOSFET in which its drain is connected to one end of the primary winding L1, its source is connected to the power supply terminal VDD of the photocoupler 2, and its gate is connected to the middle point N1, instead of the bipolar transistor. In the case of the N type MOSFET also, the terminal voltage of the power supply terminal VDD does not rise beyond the middle voltage Vm2 that is lower than the middle voltage Vm1 by about the threshold voltage of the N type MOSFET, and fixed to the voltage when the collector current that is not more than the middle voltage Vm2 becomes equal to the current consumption of the light-receiving control integrated circuit 5.

In addition, as compared with the case where the DC input voltage Vin is stepped down by the resistor R1 like in the above embodiments, the starting current can be increased at the initial stage when the collector current begins to flow, by increasing the collector current of the transistor Q4, so that the rising speed of the terminal voltage of the power supply terminal VDD of the light-receiving control integrated circuit 5 is increased, and the starting time of the switching power supply circuit 1 can be shortened.

In addition, as described above, since the terminal voltage of the power supply terminal VDD does not rise beyond the middle voltage Vm2, even when the current consumption of the light-receiving control integrated circuit 5 fluctuates, the terminal voltage of the power supply terminal VDD is prevented from fluctuating as compared with the case where the DC input voltage Vin is stepped down by the resistor R1. Thus, although the current control transistor Q2 and the current control circuit 9 are provided in the light-receiving control integrated circuit 5 to prevent the current consumption of the light-receiving control integrated circuit 5 from fluctuating and to stabilize the terminal voltage of the power supply terminal VDD in the above embodiments, in the case where the fluctuation of the terminal voltage of the power supply terminal VDD is within the operating voltage range of the light-receiving control integrated circuit 5, the circuit for stabilizing the terminal voltage of the power supply terminal VDD can be omitted.

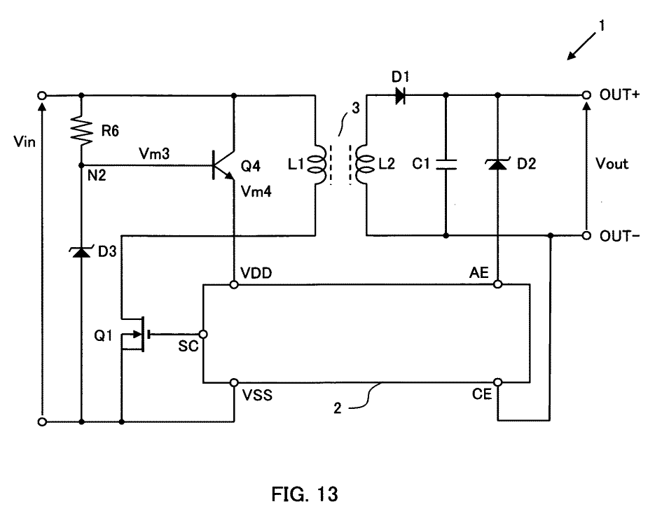

(4) Although the high resistance resistor R1 is used as the voltage step-down element to step down the DC input voltage Vin to supply the power to the photocoupler 2 in the above embodiments, as shown in FIG. 13, it is also preferable to use the NPN type bipolar transistor Q4 instead of the resistor R1. According to the transistor Q4, its collector is connected to one end of the primary winding L1, its emitter is connected to the power supply terminal VDD of the photocoupler 2, and its base is connected to a middle point N2 of a series circuit composed of a resistor R6 and a zener diode D3 connected between the one end of the primary winding L1 and the other power supply terminal VSS of the photocoupler 2, so that a middle voltage Vm3 defined by the breakdown voltage of the zener diode D3 is applied to the base. When the transistor Q4 is used, the terminal voltage of the power supply terminal VDD of the photocoupler 2 is stabilized and the starting time of the switching power supply circuit 1 can be shortened. This embodiment is the same as the above embodiments except that the resistor R1 is replaced with the transistor Q4 and the resistor R6 and the zener diode D3 are added. In addition, similar to the above other embodiment (3), the transistor Q4 may be a high voltage N type MOSFET in which its drain is connected to one end of the primary winding L1, its source is connected to the power supply terminal VDD of the photocoupler 2, and its gate is connected to the middle point N2, instead of the bipolar transistor. A description will be made of a power supply voltage supply operation to the light-receiving control integrated circuit 5 in the switching power supply circuit 1 shown in FIG. 13 hereinafter.

When the DC input voltage Vin is inputted to the one end of the primary winding L1, the middle voltage Vm3 defined by the breakdown voltage of the zener diode D3 is applied to the base of the transistor Q4, and since the emitter voltage is 0V in the initial state when the terminal voltage of the power supply terminal VDD is 0V, the collector current begins to flow from the collector to the emitter of the transistor Q4. When this collector current allows the terminal voltage of the power supply terminal VDD to rise, since the emitter voltage of the transistor Q4 rises, the voltage between the base and emitter viewed from the emitter of the transistor Q4 gradually falls and when the voltage between the base and the emitter comes close to about 0.7V, the base current of the transistor Q4 is cut off and the collector current does not flow. Thus, the terminal voltage of the power supply terminal VDD does not rise beyond a middle voltage Vm4 lower than the middle voltage Vm3 by about 0.7V, and fixed to the voltage when the collector current becomes equal to the current consumption of the light-receiving control integrated circuit 5, which is not more than the middle voltage Vm4.

In addition, as compared with the case where the DC input voltage Vin is stepped down by the resistor R1 like in the above embodiments, the starting current can be increased at the initial stage when the collector current begins to flow, by increasing the collector current of the transistor Q4, so that the rising speed of the terminal voltage of the power supply terminal VDD of the light-receiving control integrated circuit 5 is increased, and the starting time of the switching power supply circuit 1 can be shortened.

In addition, as described above, since the terminal voltage of the power supply terminal VDD does not rise beyond the middle voltage Vm4, even when the current consumption of the light-receiving control integrated circuit 5 fluctuates, the terminal voltage of the power supply terminal VDD is prevented from fluctuating as compared with the case where the DC input voltage Vin is stepped down by the resistor R1. Thus, although the current control transistor Q2 and the current control circuit 9 are provided in the light-receiving control integrated circuit 5 to prevent the current consumption of the light-receiving control integrated circuit 5 from fluctuating and to stabilize the terminal voltage of the power supply terminal VDD, in the above embodiments, when the fluctuation of the terminal voltage of the power supply terminal VDD is within the operating voltage range of the light-receiving control integrated circuit 5, the circuit for stabilizing the terminal voltage of the power supply terminal VDD can be omitted.

(5) According to the above other embodiments (2) to (4), descriptions have been made of the cases where the depression type high voltage field effect transistor Q3 in which the gate is connected to the ground, or the high voltage NPN type bipolar transistor Q4 in which the middle voltage is applied to the base, or the high voltage N type MOSFET in which the middle voltage is applied to the gate is used as the voltage step-down element to step down the DC input voltage Vin to supply the power to the photocoupler 2, instead of the high resistance resistor R1, whereby the terminal voltage of the power supply terminal VDD is stabilized as compared with the case where the high resistance resistor R1 is used as the voltage step-down element, and the current control transistor Q2 and the current control circuit 9 for preventing the current consumption of the light-receiving control integrated circuit 5 from fluctuating and stabilizing the terminal voltage of the power supply terminal VDD can be omitted from the light-receiving control integrated circuit 5.

Here, even when the high resistance resistor R1 is used as the voltage step-down element, in the case where the fluctuation of the current consumption of the light-receiving control integrated circuit 5 is previously prevented, the current control transistor Q2 and the current control circuit 9 can be omitted without using the transistor Q3 or Q4 instead of the high resistance resistor R1.

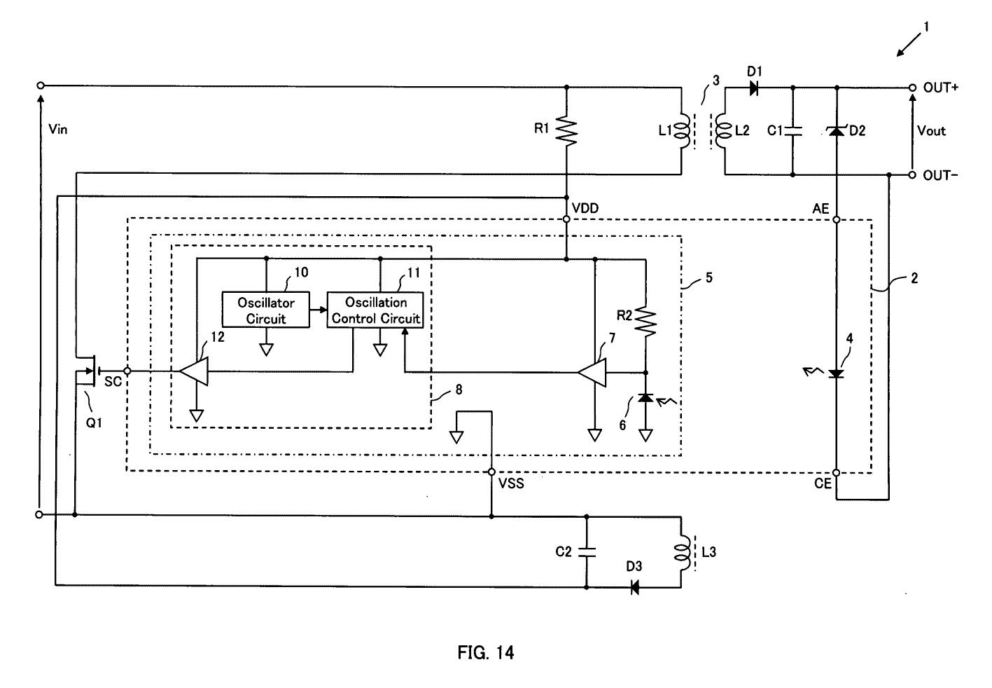

Furthermore, even in the case where the fluctuation of the current consumption of the light-receiving control integrated circuit 5 is not sufficiently prevented, and the high resistance resistor R1 is used as the voltage step-down element, when a tertiary winding L3 serving as an auxiliary winding is provided in the transformer 3 as shown in FIG. 14, the DC input voltage Vin is stepped down by the resistor R1 to be supplied at the time of the start of the switching power supply circuit 1, and after the switching power supply circuit 1 starts the switching operation once, an AC voltage is generated in the tertiary winding L3 and the DC voltage rectified and smoothed by a diode D4 and a capacitor C2 is supplied to the power supply terminal VDD. Thus, since the current consumption after the switching operation has started can be covered by the tertiary winding L3, the fluctuation of the current consumption of the light-receiving control integrated circuit 5 does not appear as the voltage between terminals of the resistor R1, so that terminal voltage of the power supply terminal VDD is stabilized. As a result, the current control transistor Q2 and the current control circuit 9 for preventing the fluctuation of the current consumption of the light-receiving control integrated circuit 5 and stabilizing the terminal voltage of the power supply terminal VDD can be omitted from the light-receiving control integrated circuit 5.

In addition, the resistor R1 in the circuit configuration shown in FIG. 14 is set so as to be higher than that in the first embodiment. More specifically, since it is only necessary to set the resistance value of the resistor R1 so that the terminal voltage of the power supply terminal VDD becomes not more than the withstand voltage of the light-receiving control integrated circuit 5 based on the case where the current consumption of light-receiving control integrated circuit 5 is small at the time of startup of the switching power supply circuit 1, the increase of the current consumption after starting the switching operation can be compensated by the tertiary winding L3.

(6) According to the above other embodiments (2) to (4), although the descriptions have been made of the cases where the depression type high voltage field effect transistor Q3 in which the gate is grounded, or the NPN type high voltage bipolar transistor Q4 in which the middle voltage is applied to the base, or the N type high voltage MOSFET in which the middle voltage is applied to the gate is used as the voltage step-down element to step down the DC input voltage Vin to supply the power to the photocoupler 2, instead of the high resistance resistor R1, a series circuit composed of the resistor R1, and the depression type high voltage field effect transistor Q3 in which the gate is grounded, or the NPN type high voltage bipolar transistor Q4 in which the middle voltage is applied to the base, or the N type high voltage MOSFET in which the middle voltage is applied to the gate may be provided, instead of providing the single high voltage element as the voltage step-down element as described above. Furthermore, since the DC input voltage Vin can be preliminarily stepped down by the resistor R1, it is also preferable to produce the transistors through the middle and low voltage process and integrate them in the light-receiving control integrated circuit 5. In the case where the series circuit composed of the resistor R1 and each of the above described transistors is provided as the voltage step-down element also, similar to the above other embodiments (2) to (4), since the terminal voltage of the power supply terminal VDD does not exceed the middle voltage Vm2 or Vm4, even when the current consumption of the light-receiving control integrated circuit 5 fluctuates, the fluctuation of the terminal voltage of the power supply terminal VDD can be prevented as compared with the case where the DC input voltage Vin is stepped down by the resistor R1 only. Therefore, although the current control transistor Q2 and the current control circuit 9 are provided in the light-receiving control integrated circuit 5 to prevent the current consumption of the light-receiving control integrated circuit 5 from fluctuating and to stabilize the terminal voltage of the power supply terminal VDD, in the above embodiments, when the fluctuation of the terminal voltage of the power supply terminal VDD is within the operating voltage range of the light-receiving control integrated circuit 5, the circuit for stabilizing the terminal voltage of the power supply terminal VDD can be omitted.
(7) Although the description has been made of the case where the transistor Q1 is the field effect transistor in the above embodiments, the same effect can be achieved by using a bipolar transistor. When the bipolar transistor is used, the gate, drain, and source of the field effect transistor are only to be replaced with the base, collector, and emitter of the bipolar transistor.

The present invention can be applied to the switching power supply circuit having the photocoupler, and can be mounted on a system required to generate a DC voltage from the commercial AC voltage, such as an AC adaptor, LED, liquid crystal television, and personal computer, so that the system can be miniaturized, an output voltage can be high in precision, and power supply consumption can be low.

Although the present invention has been described in terms of the preferred embodiment, it will be appreciated that various modifications and alternations might be made by those skilled in the art without departing from the spirit and scope of the invention. The invention should therefore be measured in terms of the claims which follow.

What is claimed is:

1. A photocoupler for feeding back output voltage information on a secondary side of a switching power supply circuit through a light signal to control a switching operation on a primary side, the photocoupler comprising:
a light-emitting element for emitting a light signal flashing based on the output voltage information of the switching power supply circuit; and
a light-receiving control integrated circuit composed by integrating a light-receiving element composed of a photodiode for receiving the light signal emitted from the light-emitting element, an amplifier circuit for amplifying an output signal of the light-receiving element, and a switching control circuit for controlling the switching operation of the switching power supply circuit, in one chip, wherein
the light-receiving control integrated circuit comprises a pair of power supply terminals supplied with a DC power supply voltage, and an output terminal for outputting a switching control signal to control the switching operation, and
the light-emitting element and the light-receiving control integrated circuit are sealed in one package so that the light signal can be transmitted from the light-emitting element to the light-receiving element.

2. The photocoupler according to claim 1, wherein
the light-receiving control integrated circuit comprises a current control transistor and a current control circuit in the one chip,
the current control transistor is provided between the pair of power supply terminals of the light-receiving control integrated circuit and controls a power supply current flowing between the pair of power supply terminals, and
the current control circuit controls a current flowing in the current control transistor so that a voltage between the pair of power supply terminals falls within a predetermined voltage range.

3. The photocoupler according to claim 1, wherein
the light-receiving control integrated circuit comprises an output drive circuit part for outputting the switching control signal of the switching control circuit and a light-receiving circuit part composed of the light-receiving element and the amplifier circuit, wherein
the output drive circuit part and the light-receiving circuit part are arranged at two opposed sides so as to be apart from each other in the one chip, and circuits other than the two circuit parts are arranged between the two circuit parts.

4. The photocoupler according to claim 1, wherein
the light-receiving element comprises a first light-receiving element for receiving the light signal, and a second light-receiving element having a shielded light-receiving part so as not to receive the light signal and having the same dark current characteristic as that of the first light-receiving element, and
the amplifier circuit comprises a first amplifier circuit for amplifying an output signal of the first light-receiving element, a second amplifier circuit for amplifying an output signal of the second light-receiving element, the second amplifier circuit having the same circuit configuration as the first amplifier circuit, and a differential amplifier circuit for amplifying a difference between an output of the first amplifier circuit and an output of the second amplifier circuit.

5. The photocoupler according to claim 1, wherein
the light-receiving control integrated circuit comprises a metal shield film covering a chip surface, and a part of the metal shield film is open so that the light signal can be inputted to the light-receiving element.

6. The photocoupler according to claim 1, wherein
a first lead frame mounted with the light-receiving element and having a lead terminal electrically connected to an input terminal of the light-receiving element by wire bonding, and a second lead frame mounted with the light-receiving control integrated circuit and having a lead terminal electrically connected to the pair of power supply terminals and the output terminal of the light-receiving control integrated circuit by wire bonding are arranged such that their chip mounted surfaces are apart from each other in a thickness direction in the one package.

7. The photocoupler according to claim 6, wherein
the first lead frame, the second lead frame, the light-emitting element and the light-receiving control integrated circuit are arranged in the one package such that the wire bonding on the first lead frame is not opposed to the light-receiving element of the light-receiving control integrated circuit on the second lead frame in the thickness direction.

8. The photocoupler according to claim 6, wherein
the first lead frame, the second lead frame, the light-emitting element and the light-receiving control integrated circuit are arranged in the one package such that the wire bonding on the first lead frame is not opposed to the light-receiving control integrated circuit on the second lead frame in the thickness direction, and the wire bonding on the second lead frame is not opposed to the light-emitting element on the first lead frame in the thickness direction.

9. The photocoupler according to claim 6, wherein
the first lead frame, the second lead frame, the light-emitting element and the light-receiving control integrated circuit are arranged in the one package such that the wire bonding on the first lead frame is not opposed to the second lead frame in the thickness direction, and the wire bonding on the second lead frame is not opposed to the first lead frame in the thickness direction.

10. The photocoupler according to claim 1, wherein
the light-emitting element is formed of a light-emitting diode composed of a GaAlAs compound semiconductor.

11. The photocoupler according to claim 1, wherein
an inner side part of a resin seal part of the one package including a space in which the light signal is transmitted from the light-emitting element to the light-receiving element is formed of a transparent resin transmitting light having a range of a sensitivity wavelength of the light-receiving element, and an outer side part of the resin seal part surrounding the inner side part is formed of an opaque resin not transmitting the light having the range of the sensitivity wavelength of the light-receiving element.

12. A switching power supply circuit comprising:
the photocoupler according to claim 1;
a transformer having a primary winding and a secondary winding;
a voltage step-down element for stepping down a DC voltage inputted to one end of the primary winding to be inputted to one of the pair of power supply terminals of the light-receiving control integrated circuit of the photocoupler;
a switching operating transistor provided between the other end of the primary winding and the other side of the pair of power supply terminals of the light-receiving control integrated circuit of the photocoupler and turned on/off by the switching control signal outputted from the output terminal of the light-receiving control integrated circuit;
a rectifying and smoothing circuit provided between both ends of the secondary winding; and
a voltage detecting element or a voltage detecting circuit for detecting an output voltage of the rectifying and smoothing circuit to be inputted to the light-emitting element as the output voltage information.

13. The switching power supply circuit according to claim 12, wherein
the voltage step-down element comprises at least one of a resistor element, a depression type FET having a gate connected to the other side of the pair of power supply terminals of the light-receiving control integrated circuit, and a transistor whose base or gate is supplied with a middle voltage between one end of the primary winding and the other side of the pair of power supply terminals of the light-receiving control integrated circuit.
